(19) United States
(12) Patent Application Publication
(10) Pub. No.: US 2004/0065375 A1
(43) Pub. Date: Apr. 8, 2004

(54) Constant acceleration and constant hydraulic diameter eliminate pressure loss in internal and external flow

(76) Inventor: John Michael Snider, Nashville, TN (US)

Correspondence Address: John Michael Snider, 4500 Wayland Drive, Nashville, TN, 37215, US

(21) Appl. No.: 10/265,491

(22) Filed: Oct. 7, 2002

(51) Int. Cl. F15D 1/00

(52) U.S. Cl. 138/39; 138/37

(57) ABSTRACT

Moving fluids are subjected to acceleration forces in turns, contractions, expansions and when flowing around bluff bodies. These forces can result in losses that are much larger than friction losses. For internal flow contractions, it is known that constant acceleration will eliminate pressure losses by balancing the forces that cause these accelerations with changes in static pressure. This disclosure teaches how to provide constant deceleration forces in expansions (diffusers) by maintaining a constant area to shear surface ratio, known as hydraulic diameter. Also taught, is how to design a turn vane array that has a hydraulic diameter equal to the upstream ducting diameter. Lastly, that these design techniques apply equally well to external flow regimes and a simple calculation demonstrates this method. Constant Acceleration Fluid Dynamics, results in ducting and bluff bodies that have no losses other than friction.

### SUMMARY OF INVENTION

Moving fluids are subjected to acceleration forces, in turns, in contractions, in expansions and when flowing around bluff bodies. These forces can result in losses that are much larger than the losses associated with friction on the surface of these conduits and bluff bodies, particularly in the case of expansions. For internal flow, it is known that constant acceleration will eliminate pressure losses by balancing the forces that cause these accelerations with changes in static pressure caused by the velocity changes in the fluid due to these accelerations. Below, is a disclosure that teaches how to provide constant deceleration forces in expansions, or diffusers, by maintaining a constant area to shear surface ratio, known as hydraulic diameter. Also taught, is the importance of designing a turn vane array that has a hydraulic diameter equal to the upstream ducting diameter. Lastly, that these design techniques apply equally well to external flow regimes and a simple calculation demonstrates this method. Such balanced flow results in ducting and bluff bodies that have no losses other than friction. The essence is that when fluid acceleration and hydraulic diameter are constant, the forces required to accelerate the fluid and the static pressure changes caused by velocity changes are balanced.

| | | | |
|---|---|---|---|
| 5,662,079 | September, 1997 | Snider | 123/188.14 |
| 4,174,734 | November, 1979 | Bradham, III | 138/39 |

### BACKGROUND

This work had the goal of increasing the amount of air going into and out of an engine, by reducing the flow losses that occur in a modern compact engine. These engines have many ninety-degree or sharper turns in the flow paths both going in and coming out. Turns with the ideal inside radius to flow path diameter ratio (2.0) reduce the flow by one half compared to a straight section of the same diameter passage with the same length and same pressure differential. However, turns in the passages of production engines rarely have such large radius to diameter ratios. A common V-8 engine has passages that are one and one half inches in diameter and the inside radius of a turn with the least flow losses is three inches. Such a large radius turn in the cylinder head would result in a large engine. Actual inside radii are one half to three quarters of an inch or less and large flow losses occur.

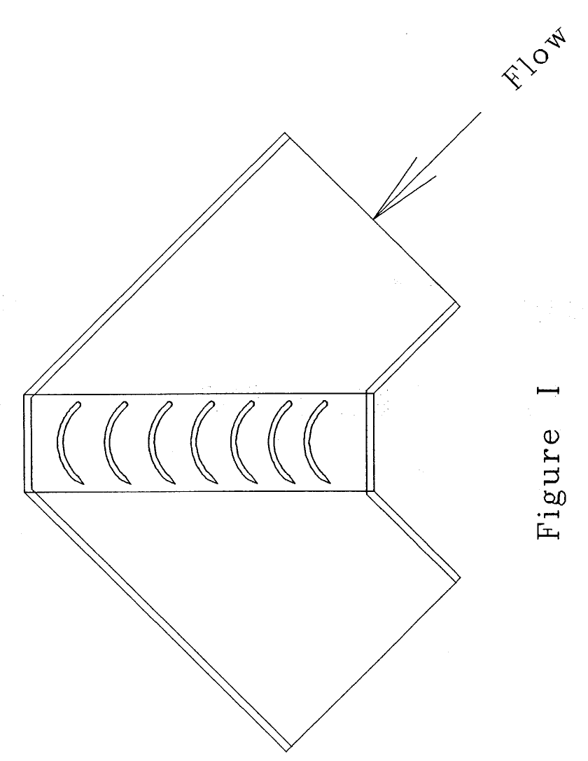

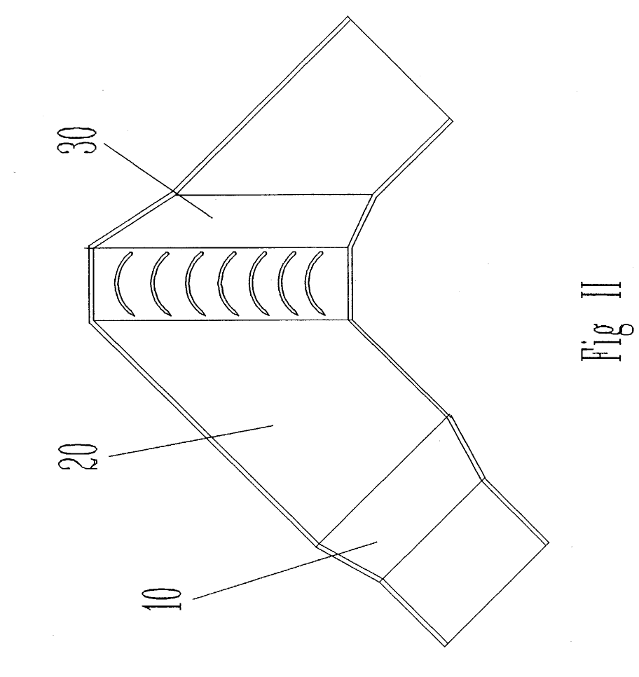

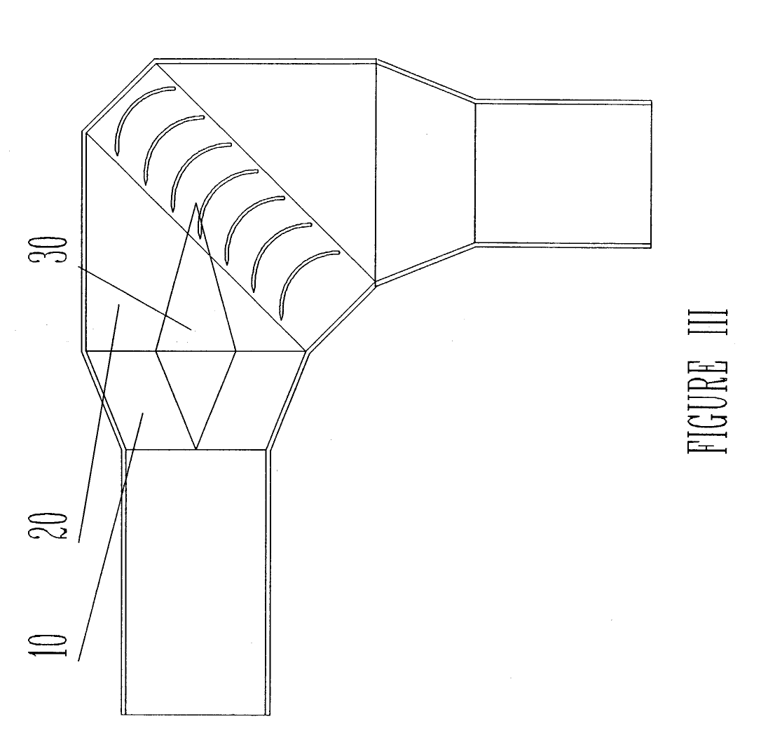

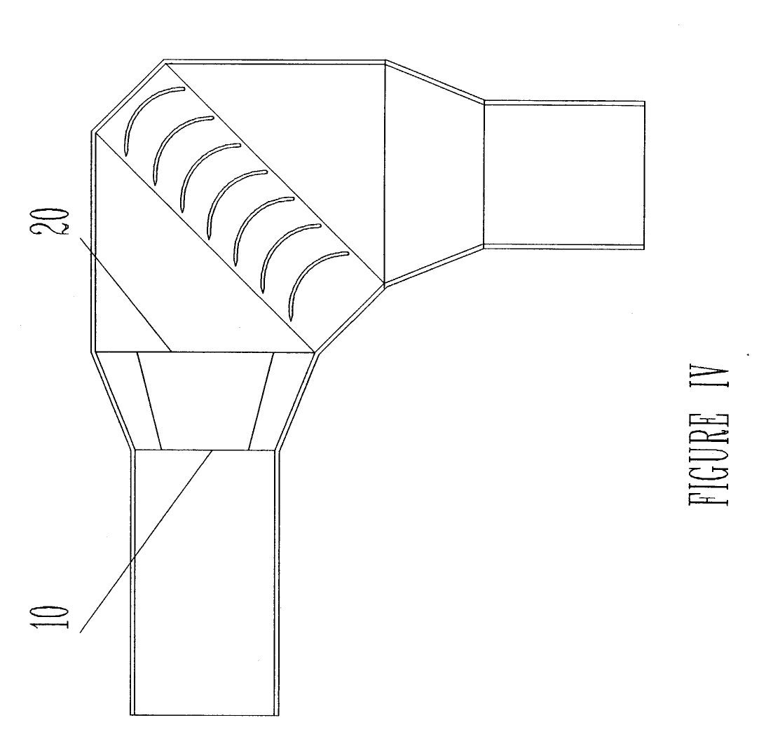

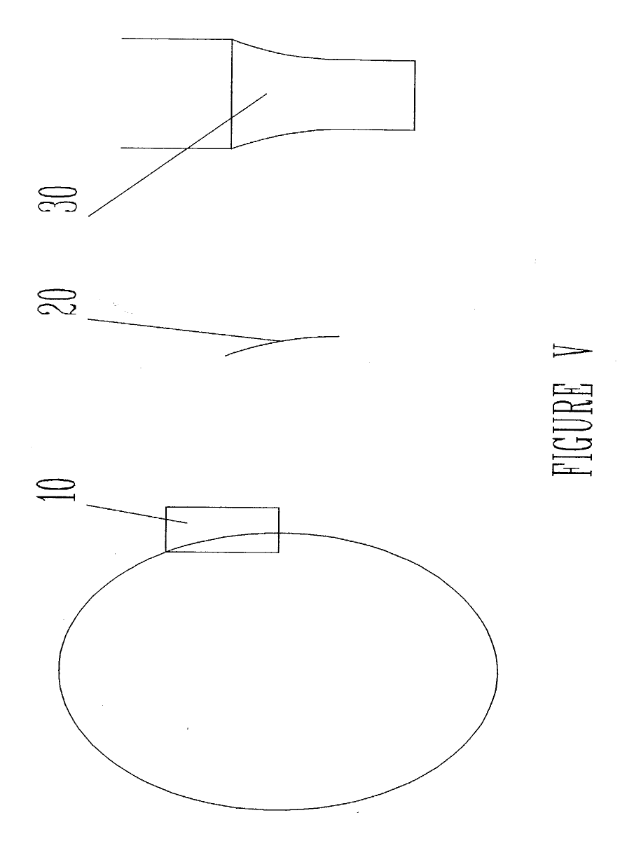

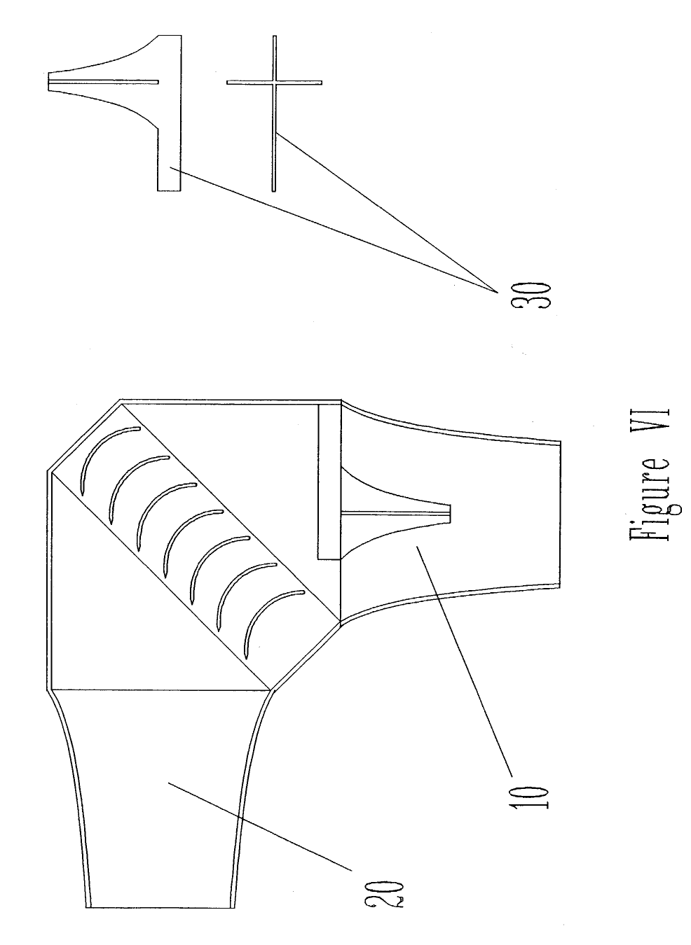

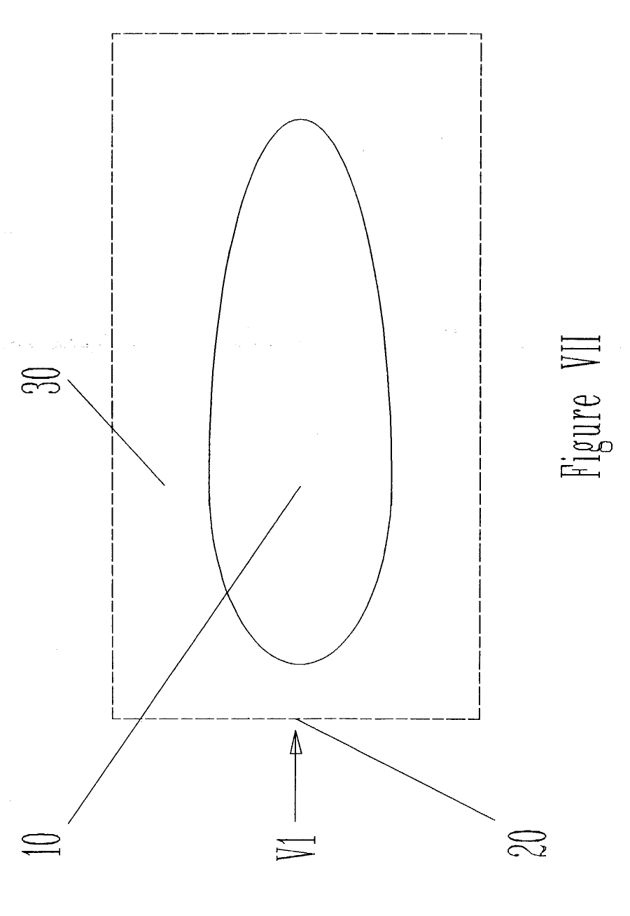

Turn vanes have been known to aid flow around turns particularly turns that have no inside radius, the mitered turn. Refer to U.S. Pat. No. 5,662,079 for more background. Using turn vanes to provide the force to accelerate fluids around turns in an engine seemed a natural application. Testing began with the construction of a turn vane array with a geometric progression outlined in the reference patent. The array's elliptical section had a major axis that was the square root of two times the diameter of the ducting (the minor axis). Small block Chevrolet engines use one and five eighths inch tubing with and 0.049 inch wall thickness for headers typically (diameter is 1.527). Thus, the major diameter of the elliptical array is 2.16 inches. See FIG. 1. Testing of this array, installed in a mitered cut made in the header tubing, found larger losses than a turn of ideal inside radius to diameter ratio.

Analysis of the results determined that the frictional effects of all of the surfaces in the eight passages making up this array hinder the flow. The area in the middle of the array is larger than the ducting leading to and away from the turn vane array, yet still flow was less. Construction began on a larger array, with the minor axis of the array equal to the duct diameter plus the thickness of two boundary layers. Noise levels near the wall of the tube revealed that the boundary layer thickness is 0.2 inches (fully turbulent flow). An additional 10 percent to address measurement uncertainty yields a final array diameter of 1.527 plus 0.440 or 1.967. The major axis of the array became the square root of two times the minor axis squared or 1.967 yielding 2.781758 inches. A conical section, 1.527 inches in diameter at small end and 1.967 inches at the large end with a length of 0.7635 inches formed the transition for the downstream ducting. See FIG. II, 10. A section of 1.967 inch diameter straight tubing with a miter cut joined the conical section to the array and the length was 2.5 inches along the centerline of the straight section (FIG. II, 20). The inlet transition is a cone with a forty five-degree miter cut on the big end that attaches to the array (FIG. II, 30). Flow testing of this larger array and its transitions showed an improvement over the original array. Yet, the flow was still less than a turn of ideal inside radius to diameter ratio and far less than a straight section of similar length.

Additional experimentation with this arrangement revealed that the transitions had an effect on how well the flow made it through the array. I.e., flow increased when it came into the array from the longer transition compared to the other direction. This showed that it was possible to have improved flow in one direction and hinder flow in the other. Such a gating effect is beneficial to a reciprocating engine's performance.

To understand the frictional effects on turn vane flow the idea of Hydraulic Diameter was used to calculate the equivalent diameter of a round duct for the entrance and exit of an array. Hydraulic Diameter is four times the area perpendicular to a flow divided by the wetted perimeter; where wetted perimeter is a surface that has a boundary layer with shear and friction occurring. In a round duct, the Hydraulic Diameter (HD.):

$$\frac{4 \times Area}{Perimeter}$$

Becomes:

$$\frac{4 \times ( Pi ) \times {( Diameter )}^{2}}{( Pi ) \times Diameter \times 4}$$

Or simply:

### Diameter

Ninety-degree turns, even those with the ideal diameter to inside radius ratio (two), effect the flow even before it enters the turn. Low pressure created by accelerating flow sweeps the flow path to the outside of the turn at the entrance. Near the entrance, the flow crosses and accelerates to the inside half of the duct in the middle of the turn. Flow, now moving at twice the duct velocity, continues across the turn to the outside for the exit. It is important to note that sonic velocity occurs inside the turn when the velocity of the straight sections of the conduit is half sonic speed. Ninety-degree turns in a duct with blow down events, such as an exhaust pipe, will flow much less than a duct without the ninety-degree turn.

At the middle of the turn the flow area is one half that of the duct. The wetted perimeter is one half the circumference of the duct. Thus, the hydraulic diameter is one half the area divided by one half the wetted perimeter or the diameter of the duct. Fluid in the duct accelerates to twice the free stream velocity in the middle of the turn (since the flow area is one half) and is decelerated back to free stream velocity below the turn. This separation from the duct walls leads to voids where eddies form and cause large flow losses. Interestingly, turns of greater than ninety degrees have the same flow loss as a ninety-degree turn.

Calculation of the area of each passage is the first step in determining the hydraulic diameter of the turn vane array. Integration of the equation of a circle produced a function that expressed the area of part of a circle. This part of the circle is from the bottom of the circle to the top of the portion of interest. The area of the passage is the area of the top of the passage subtracted from the area of the bottom of the passage. A similar calculation was used to find the wetted perimeter length of each flow path in the vane array. The hydraulic diameter of the array is the square root of the sum the squares of the hydraulic diameter of each path.

The common exhaust tubing inside diameter in a small block Chevrolet engine is 1.527 inches (one and five eighths inch eighteen-gauge tubing.) Using the hydraulic diameter calculations, from above, yields an inside diameter of 2.4 inches and an area ratio of 2.47. From the continuity equation, the velocity of the flow is 0.405 of the exhaust tubing velocity for full use of the turn vane array. Similarly, the flow must accelerate 2.47 times after leaving the array to enter the exhaust tubing.

Such a large change from the duct velocity may seem at first thought to be unnecessary. Recalling that the flow in the middle of a corner accelerates to twice the duct velocity means that the peak velocity in the middle of the turn vane array will always be below the velocity in the duct. This fact is important when the duct is carrying a gas. Since the maximum mass flow rate that can pass occurs when the velocity in the duct equals the speed of sound in the gas. A turn vane array will pass twice the amount of an unvanned turn when duct velocities approach the speed of sound in the duct.

Tests of transitions of various designs occurred. The goal was to change the speed of the duct flow before and after the turn vane array. The first transition tested was an orthogonal section of a cone with a base diameter of 2.4 inches, an upper section diameter of 1.527 inches, and a section height of 1.08 inches, with a forty-four degree cone angle. See FIG. III, 10. A straight section of 2.4 inch diameter tubing 1.2 inches long at the centerline was miter cut to transition from the round cone base to the elliptical array entrance (FIG. III, 20). This transition must slow and spread the flow evenly across the flow area of the turn vane array for minimum losses. To spread the flow, the leading portion of a conical internal bluff body installed in the conical section of the transition. While the down stream end of the bluff body is in the straight section of the transition to allow the flow to spread out with over the area of the turn vane array with minimal loss. This body had a maximum diameter of 2.4 minus 1.527 or 0.873 inches (FIG. III, 30). The leading and trailing cone angles were forty-four and thirty-three degrees respectively to minimum bluff-body drag and loss. Testing showed that flow losses still occurred. Testing also revealed that the conical transition, when used in the convergent direction, also caused flow losses.

Evaluation of the failure of the bluff body to slow and redistribute the flow stream across the larger area of the down stream duct without loss lead to another idea Divide the flow into two streams using a cone section and reunite them in the larger downstream area. Calculation of the diameter of the entrance of the second cone and the diameter of the outer passage involved writing the hydraulic diameter equation for an annulus. Setting it equal to the diameter of the upstream piping, and solving for both using the fact that they have equal hydraulic diameters. Namely, 1.527 squared divided by two taking the square root of the quotient yields: 1.0798 square inches and a corresponding diameter of 1.1725 inches. See FIG. IV, 10. Similarly, division of the exit of the transition required using an annulus with equal hydraulic diameter paths. This time it is 2.4 inches squared, divided by two and the square root of the quotient yields: 1.6970 inches squared and a diameter with this area of 1.47 inches, FIG. IV, 20. Testing of this divergent transition found that the flow was even across the larger diameter downstream piping yet large flow losses were required to make the transition.

Internal Flows

Since both bluff bodies and conical subsections failed to eliminate the flow losses the shape of the transition became, suspect. Water undergoing a constant acceleration, such as the pull of gravity, forms an elliptical appearing flow field. An observer can see this when water leaves a facet and falls into a sink. Near the facet, the crossectional area of the water converges rapidly. The rate of the convergence slows the farther the water is from the facet until the flow stream breaks into droplets. When a facet is in laminar flow, i.e., very slow flow, the shape of the sides of the flow stream appear to correspond to an ellipse.

A converging nozzle made using an elliptical shape with a major radius of twice the inlet duct diameter and a minor radius of twice the outlet duct diameter became the first test transition. See FIG. V, 10. The shape is a small section of this ellipse that starts at the intersection of the minor axis and moves toward the major axis until the tangent line is twenty degrees from perpendicular to the minor axis, FIG. V, 20. The nozzle is the revolution of this portion of the ellipse about an axis one half the small diameter away, FIG. V, 30. Testing of this nozzle in the converging direction found that the flow accelerated with no apparent flow losses (other than Friction). In the divergent direction, the losses remained and the flow did not decelerate and cover the larger flow area.

Derived below is an expression for diameter as a function of position using the Continuity Equation and the Equations of Motion with Constant Acceleration:

Mass Flow Rate (m)=rho(density) times A(area) timesV(Velocity) or restated:

m=rhoAV

In addition, since the mass flow rate going in the nozzle (1) equals the mass flow rate going out (2):

m₁=m₂

rho₁A₁V₁=rho₂A₂V₂

Assuming little change in density, i.e., rho₁=rho₂ and solving for V₂ yields:

$${V}_{2} = \frac{{A}_{1} {V}_{1}}{{A}_{2}}$$

The use of substitution and the equations of motion with constant acceleration to eliminate time results in:

V₂²=V₁²+2a(X₁−X₂)

Eliminating V₂ from the preceding equations:

$$\frac{{A}_{1}^{2} {V}_{1}^{2}}{{A}_{2}^{2}} = {V}_{1}^{2} + 2 a ( {X}_{1} - {X}_{2} )$$

Since

$$\frac{{A}_{1}}{{A}_{2}} = \frac{{D}_{1}^{2}}{{D}_{2}^{2}}$$

And substituting the above produces a function of duct diameter:

$${\vert \frac{{D}_{1}}{\vert \frac{2 a ( X )}{{V}_{1}^{2}} \vert + 1} \vert}^{1 / 4} = D2$$

Use of the foregoing relationship requires choosing a transition length X and solving for acceleration (a) using known inlet and outlet hydraulic diameters. This acceleration goes into the equation to calculate duct hydraulic diameter at points less than the transition length. Bradham, ILL. discloses this in his U.S. Pat. No. 4,174,734.

### BRIEF DESCRIPTION OF THE DRAWINGS

FIG. I is a section of a turn vane array in a mitered cut round duct.

FIG. II depicts a turn vane array (in section) that is larger than the array in FIG. I by two boundary layer thickness plus ten percent. It also shows some transitions that were tried form the duct diameter to the larger array diameter.

FIG. III is a section of a turn vane array that has a hydraulic diameter equal to the duct diameter and uses conical transitions and a bluff body to direct the flow into and out of the vane array.

FIG. IV is the same view of the array shown in FIG. III that shows a conical diffuser inside of the conical transition.

FIG. V is a depiction of a transition based on a section of an ellipse. It shows an ellipse, a section of the ellipse and the resulting revolution of that section which is the transition.

FIG. VI is of a turn vane array, in section, that has a hydraulic diameter equal to the inlet and outlet ducting. The array uses a constant acceleration transition (10) with cruciform shaped shear surfaces (30) that maintains constant hydraulic diameter and decelerates the duct flow to match the velocity in the turn vane array. Flow returns to duct speed in the outlet transition (20) and undergoes constant acceleration to avoid pressure loss.

FIG. VII shows a bluff body in a flow stream moving at V1, the analytic surface that flow changes occur in (20) and the relative sizes of the bluff body and the flow volume (30).

### SUMMARY OF THE INVENTION

The problem of decelerating the flow through a divergent constant acceleration transition remains. Keeping the hydraulic diameter equal to the inlet diameter (the small diameter) along the transition will force deceleration and a flow area increase. Creation of a table of the hydraulic diameter minus the small hydraulic diameter along the transition showed that a central four finned shape, a cruciform, would have the shear surfaces needed to provide a constant hydraulic diameter in the expansion. To test this design, it was first necessary to fabricate a ninety-degree turn vane array with a constant hydraulic diameter, constant acceleration divergent upstream transition, see FIG. VI, 10, and a constant acceleration, convergent downstream transition, FIG. VI, 20. Constant hydraulic diameter is maintained by the cruciform depicted in FIG. VI, 30. Testing showed that flow losses were half that of an ideal radius unvaned turn.

Reversing the flow developed losses equal to an ideal radius turn without vanes. In a pulsating system that has flow in one direction, like a reciprocating internal combustion engine, this gating effect will improve efficiency by reducing reversion, particularly at high engine speeds. Use of transitions with constant acceleration and, when divergent, constant hydraulic diameter, reduce flow losses in other engine components.

Constant hydraulic diameter, Constant acceleration, Diffusers (CCD) can be used in many fluid systems to slow a small high velocity low pressure stream to form a larger low velocity high pressure stream. Some applications are pumps, compressors, fans, turbo-machinery, Heating Ventilating and Air Conditioning systems, air intake silencers, mufflers, hypersonic aircraft engines, hydraulic systems, and countless others. CCD equipped Turn Vane Arrays installed in, manifolds, cylinder head inlet and outlet passages, intake and exhaust piping and airplane lifting devices can all be improved upon by using these transitions with or without turn vanes.

External Flows

External flow analysis is more complicated than internal flow analysis. Some similar simplifying assumptions are required to make it possible. Including, ignoring friction effects and assuming that the flow is uniform at each point along the flow path. A bluff body in an infinite flow field accelerates a portion of the flow field outward so it may pass by the bluff body. From here on, the this portion of effected flow field is defined as the “control surface”(_{cs}). Beyond this effected flow area the flow field has the same velocity as the infinite flow field. Point 1 is defined as being immediately upstream of the point where flow is effected by the bluff body and where pressure and velocity is equal to the infinite values. Point 2 is where the maximum area of the bluff body occurs.

A Mass Analysis yields:

mass flow rate 1=mass flow rate 2

Since mass flow rate equals:

density(rho) times Area(A) timesVelocity(V)

rho₁A_{cs}V₁=rho₂(A_{cs}−A₂)V₂

If V₁ and V₂ are much less than the sonic velocity, than rho₁ and rho₂ will be nearly equal and the above becomes:

A_{cs}V₁=(A_{cs}−A₂)V₂

Solving the above for Acs yields:

$${A}_{cs} = \frac{{A}_{2}}{1 - {V}_{1} / {V}_{2}}$$

The equations of Motion for constant acceleration are as follows:

X=X₀+V₀t+½at²

Where X is distance, V is velocity, a is acceleration and t is time.

The first derivative is:

V=V₀+at

Solving for t yields:

t=(V−V₀)/a

Substituting the equation for t into the equation for X and solving for a yields:

$$a = \frac{{V}^{2} / 2 - {V}_{0}^{2} / 2}{X - X0}$$

Below is a force analysis that considers the following: The bluff body pushes the moving fluid around the bluff body and causes it to accelerate. The fluid picks up speed, and since there is no work and no heat transfer done to the fluid, the kinetic energy the fluid gains is equal to the drop in potential energy of the fluid. This potential energy is the static pressure around the bluff body. Balancing this pressure force the force needed to accelerate the fluid, requires that these values must be equal, therefore:

Force equals mass times acceleration:

F=ma

Substituting the pressure force, the mass flow rate and constant acceleration terms into the above yields:

$${P}_{2} {A}_{2} = \frac{rho {A}_{2} {V}_{1}}{1 - {V}_{1} / {V}_{2}} \frac{\frac{{V}_{2}^{2}}{2} - \frac{{V}_{1}^{2}}{2}}{{X}_{2} - {X}_{1}}$$

Now considering the energy equation mentioned above, is the following analysis:

Q−W=the sum of (P/rho+V/2+gz+u)m

Where:

Q is heat transferred per unit mass

W is work done to or by each unit mass

P is pressure (potential energy)

rho is the density of the working fluid

V is the velocity

g is a gravitational constant

u is the internal energy of the fluid

and m is the mass flow rate of the fluid.

“The sum of” is the sum of each of the flow streams into and out of the control volume.

Applying the energy equation to points 1 and 2 of the bluff body yields:

$${P}_{2} = rho \frac{{V}_{1}^{2}}{2} - \frac{{V}_{2}^{2}}{2}$$

Substituting this expression for P₂ into the force balance equation and solving for V₂ yields the following:

V₂=V₁+(X−X₀)

Thus, when V₁ and X equal one and X₀ is zero V₂ is two. The result is that the velocity at the largest area of the bluff body is twice that of the free stream velocity and that the area of the control volume is twice the area of the bluff body. Of course, this is only true in a fluid without friction, where constant acceleration occurs and there are uniform velocity distributions at point one and two.

Knowing the velocity at point 2 it is possible to go back to the final equation derived above and write an equation that yields the area or the hydraulic diameter of the bluff body. This equation is a function of the distance X between points one and two and gives the shape of a bluff body that causes constant acceleration of the fluid flowing over it.

Constant deceleration of the fluid flowing over the rear portion of the bluff body eliminates the pressure loss at the rear portion of a bluff body in a similar fashion. Negative pressure required to force the fluid to slow is balanced by the increase in static pressure as the fluid slows. Shear surfaces designed to maintain constant hydraulic diameter will help slow the speed of the fluid on the back side of the bluff body just as the cruciform shaped section did in expanding transitions in internal flow.

Air, land and marine vehicles all can be more efficient by shaping them to provide constant acceleration and deceleration of the medium through which they travel. Effects such as compressibility, density changes, internal energy changes, friction, viscosity, and temperature changes can be included in the above analysis to maintain constant acceleration in high-speed machines.

This disclosure teaches that when fluids undergo constant acceleration there are no pressure losses. The forces providing the acceleration are equal and opposite to the force caused by the change in both static pressure and area along the path of constant acceleration. Further, shown above, is how to design constant acceleration paths, both transitions for internal flow and bluff body shapes for external flow paths, to eliminate pressure losses. Finally, also revealed above, is how to produce constant deceleration forces along a flow path that are opposite and equal to both static pressure and area increases. In the case of internal flow, shear surfaces are place along the flow path to maintain constant hydraulic diameter. In a similar fashion, using shear surfaces will slow the exterior flow on the downstream side of bluff bodies.

Where ever there is fluid motion these lessons and analytical approach offers an improvement over prior practice or prior art, greatly improving the efficiency of fluid flow devices. It is not the aim of this disclosure to identify all the possible uses of these lessons and the possible application of these analytical techniques. Rather, to show how to use them so to reduce fluid flow losses and achieve energy savings and or performance improvements in fluid systems where ever they are. In this spirit, I claim the following: What is claimed.

I claim:

1. A transition from smaller to larger ducts that are shaped to provide a constant acceleration of fluid moving through said transitions.

2. The device of claim 1., fitted with an internal shape so as to have constant hydraulic diameter all along the length of the transition and equal to the smallest end of the transition.

3. The device of claim 2 where the internal said shape is a cruciform and causes the same hydraulic diameter (the minimum) along the length of the transition.

4. The above constant acceleration devices of claim 2. fitted up stream and down stream of a turn vane array to move fluid around turns with minimal flow losses in both directions.

5. The device of claim four where upstream and downstream constant acceleration transitions are fitted with shapes that maintain constant hydraulic diameter equal to the ducting reducing flow losses in both directions.

6. The device of claim five where one of the constant hydraulic shapes is removed so as to provide favorable flow in one direction but not in the other.

7. The turn vane array devices in claim 4., 5., and 6. where each flow passage is of equal hydraulic diameter and where the square root of the sum of the squares of these flow passages hydraulic diameters equals the diameter of the ducting leading to and away from the turn vane array.

8. The device of claim 2. where the minimum diameter is chosen so as to allow a predetermined portion of the flow from the supplying conduit to move through to a branch line downstream of the said device at a slower velocity without pressure losses where said branch line is larger than the predetermined minimum diameter.

9. A bluff body whose shape provides for constant acceleration of the fluid flowing over the front and constant deceleration of the fluid flowing over the back of said bluff body.

10. The bluff body in claim 8. Where the pressure increase at the front of the bluff body is equal to the pressure decrease caused by the velocity gained by the fluid acting over the increasing area. In addition, the pressure drop needed to decelerate the fluid over the rear of the bluff body is equal to the pressure gained by the slowing fluid acting over the decreasing area at the rear of the bluff body.

11. The bluff body in claim 8., where the rear portion has shear surfaces to maintain constant hydraulic diameter (equal to or less than the largest hydraulic diameter of the bluff body) so as to decelerate the fluid flowing over the back of the bluff body in the shortest distance possible.

12. The bluff body in both claims 8. and claim 9. That maintains constant acceleration and force balances when the fluid has pressure, density, temperature, and internal energy changes which all have an impact on the forgoing.

13. For internal flow, a function that relates the duct diameter to position along the path of constant deceleration using any form of both the equations of motion and the continuity equation to derive said function and whose third derivative with respect to time is zero.

14. For external flow, a function that relates bluff body hydraulic diameter to position along the length of the bluff body using any form of the equations of motion, energy equation, and conservation of mass equations to derive said function and whose third derivative with respect to time is zero.
